(19) United States
(12) Patent Application Publication
(10) Pub. No.: US 2008/0162002 A1
(43) Pub. Date: Jul. 3, 2008

(54) Safety Device For a Motor Vehicle

(75) Inventors: Werner Bacher, Sindelfingen (DE); Ralf Bogenrieder, Stuttgart (DE); Martin Pfieffer, Holzgerlingen (DE); Dominic Reutter, Ebersbach (DE); Friedhelm Sawinsky, Aidlingen (DE); Matthias Walz, Kirchentellinsfurt (DE); Wilfried Walz, Nagold (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/587,084

(22) PCT Filed: Apr. 12, 2005
(86) PCT No.: PCT/EP05/03807

§ 371 Date: Oct. 24, 2007

(30) Foreign Application Priority Data
Apr. 23, 2004 (DE) 10 2004 020 049.1

(51) Int. Cl. B60R 22/06

(52) U.S. Cl. 701/45; 280/804

(57) ABSTRACT

A safety device is provided for a motor vehicle having a vehicle seat whose seat setting can be adjusted by a seat adjustment drive. A seat control unit evaluates data that is relevant to the safety of a driving mode and actuates the seat adjustment drive with timing. Thereby, movement of the vehicle seat into a seat setting occurs that is optimum for a vehicle occupant in terms of safety technology is initiated before the occurrence of an anticipated accident event. Movement of the vehicle seat into its optimum seat setting in terms of safety technology is carried out successively in individual adjustment steps for the respective components of the vehicle seat in a predefined sequence by the seat control unit.

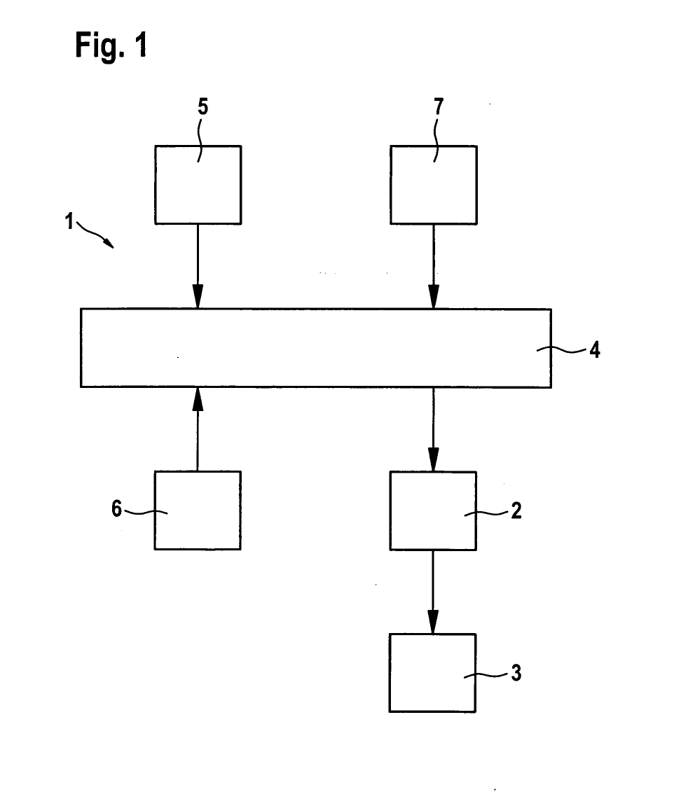

### RELATED APPLICATIONS

This invention is a U.S. National Phase Entry under 35 U.S.C. § 371 of PCT/EP2005/003807, which claims priority to 10 2004 020 049.1, filed Apr. 23, 2004.

### BACKGROUND AND SUMMARY OF THE INVENTION

The invention relates to a safety device for a motor vehicle having a vehicle seat whose seat setting can be adjusted by a seat adjustment drive, and a seat control unit with evaluation of data which is relevant to the safety of the driving mode.

DE 197 49 838 A1 discloses a safety device for a motor vehicle, in which a signal of a precrash sensor for detecting the risk of an impact is used to activate components of a restraint system of a vehicle seat whose settings and positions are optimized for an actual impact. After an impact fails to occur, the components are returned to their original setting and position. The components are, for example, seatbelt pretensioners, backrests, upholstered foot elements for protecting the lower extremity region of a vehicle occupant and the lower part of the vehicle seat so that the vehicle seat can be moved forward or backward as a function, for example, of the size of the vehicle occupant sitting on the respective vehicle seat.

DE 1 99 46 407 A1 describes a system for the selective activation of passive restraint components in a motor vehicle, which system has at least one precrash sensor. The precrash sensor generates an activation signal for more wide-ranging precrash measures when a directly imminent collision of the moving motor vehicle with an obstacle is detected. The precrash sensor can, for example, be implemented as a radar sensor or as an optical sensor with triggering electronics connected downstream.

Furthermore, DE 101 21 386 C1 discloses a method for actuating a reversible vehicle occupant protection means in a motor vehicle having a sensor system which senses driving state data. The emergency braking operations, oversteering and understeering of the motor vehicle are sensed as driving state data. The vehicle occupant protection means are triggered as a function of such a state. In addition, the direction from which a maximum risk is to be anticipated can be determined from the driving state data. The vehicle occupant protection means is actuated in such a way that the protective effect is implemented in accordance with the direction of maximum danger.

Furthermore, DE 44 11 184 C2 describes a restraint seatbelt system for a seat in a motor vehicle having a seatbelt and a seatbelt pretensioner for protecting a passenger on the seat. The distance from an object and the corresponding relative speed are determined with a device. The anticipated time until the possible collision between the vehicle and the object can be determined from this. A control unit generates a control signal which increases the force of the seatbelt pretensioner in good time before the possible collision. If a collision can be avoided, the force of the seatbelt pretensioner is reduced again. The controllable seatbelt pretensioner is embodied as a pretensioning means which is effective before the collision only up to a predefined level of stress, a further seatbelt pretensioner being triggered to apply the seatbelt more tautly if the collision is actually detected.

An object of the present invention is to provide a safety device for a motor vehicle having a vehicle seat whose seat setting can be adjusted by a seat adjustment drive, and a seat control unit with evaluation of data that is relevant to the safety of a driving mode, which safety device provides a raised level of vehicle occupant protection compared to prior art safety devices .

The aforesaid object is achieved by a safety device for a motor vehicle having a vehicle seat whose seat setting can be adjusted by a seat adjustment drive, and a seat control unit with evaluation of data which is relevant to the safety of a driving mode.

According to the invention, the movement of vehicle seat into its optimum seat setting in terms of safety technology is carried out successively in individual adjustment steps for the respective components of the vehicle seat in a predefined sequence by means of the seat control unit. The safety device for a motor vehicle comprises the vehicle seat whose seat setting can be set by the seat adjustment drive, and the seat control unit with evaluation of data that is relevant to the safety of the driving mode. The seat control unit actuates the seat adjustment drive with timing such that the movement of the vehicle seat into its seat setting which is optimum for the vehicle occupant in terms of safety technology is initiated before the occurrence of the anticipated accident event. With the present safety device, in particular by virtue of the individualized definition of the sequence of the individual adjustment steps for the respective components of the vehicle seat, a high degree of vehicle occupant protection is ensured.

The sequence can be predefined as a function of various safety parameters, for example as a function of the type and severity of the accident event. The time directly before the accident event is already utilized in order to initiate preventive measures for improving the vehicle occupant safety. A preventative vehicle occupant protection apparatus is made available with the safety device which acts in a preventative fashion.

It is advantageous here if the adjustment steps for the respective components of the vehicle seat are divided into at least two groups with a predefined sequence in the respective group so that adjustment steps composed of different groups can be carried out in parallel. The seat setting that is optimized in terms of safety technology can be set quickly by the parallel processing of adjustment steps. This is highly important for the vehicle occupant protection apparatus that acts in a preventative fashion.

In one aspect of the invention, the optimum seat setting in terms of safety technology and/or the sequence of the adjustment steps are dependent on a seatbelt system of the vehicle seat being put on. For example, it is appropriate to select a less acute angle of inclination of the seat cushion in a stage when the seatbelt has not been put on than in a state in which it has been put on. The sequence for the adjustment scenarios for the seat setting is defined differently as a function of the seatbelt system being put on. In the state in which the seatbelt has been put on, longitudinal adjustment of the seat and adjustment of the backrest occur followed by adjustment of the angle of inclination of the seat cushion and vertical adjustment, while in the state in which the seatbelt has not been put on the sequence of the adjustment activities is reversed.

In a further aspect, the optimum seat setting in terms of safety technology and/or the sequence of the adjustment steps depend on the current seat setting of the vehicle seat. For example, for the longitudinal adjustment of the vehicle seat there is not just one position for the optimized longitudinal setting of the vehicle seat in terms of safety technology. The optimized longitudinal setting of the seat in terms of safety technology depends on the current longitudinal setting of the seat. If the current longitudinal setting of the seat is, for example, in the front region, the associated optimized longitudinal setting of the seat in terms of safety technology for this current longitudinal setting of the seat is also in the front region.

The data which is relevant to the safety of the driving mode may, in particular, comprise driving state variables. Variables such as the speed of the vehicle, yaw acceleration, longitudinal acceleration and lateral acceleration, brake pedal position and accelerator pedal position and the steering angle are used as driving state variables. Furthermore, the status of operator control elements such as the indicator flasher light and warning flasher light as well as the status of sensors and control units which relate to the motor vehicle can be used as driving state variables.

Alternatively or additionally, the data which is relevant to the safety of the driving mode may comprise ambient data. The term ambient data refers to data that is made available by ambient sensors, telematics systems and by communication between the motor vehicle and other motor vehicles and fixed communication systems. Examples of ambient data comprise information relating to the current location, information relating to the category of street and information relating to the lane on which the driver's own motor vehicle is traveling. Further ambient data includes the state of the road, the temperature, the weather conditions, light conditions as well as speed, distance, type and size of motor vehicles traveling ahead, alongside, behind or on an oncoming lane, and of other road users.

It is advantageous if the data which is relevant to the safety of the driving mode comprises evaluated driver activities. Sensing the driver activity comprises, for example, detecting the eye movements, the viewing direction or else the operator control processes of operator control elements such as, for example, the steering wheel, gear speed selector lever and brake pedal. By evaluating a multiplicity of data items which are relevant to safety it is possible to determine, as necessary, the correct time for closing the sunroof by means of the coordination unit.

### BRIEF DESCRIPTION OF THE DRAWING

Other objects, advantages and novel features of the present invention will become apparent from the following detailed description of the invention when considered in conjunction with the accompanying drawings, in which the single FIGURE is a block diagram of a detail of a safety device for a motor vehicle having a vehicle seat whose seat setting can be adjusted by a seat adjustment drive, and a seat control unit with evaluation of data that is relevant to the safety of a driving mode.

### DETAILED DESCRIPTION OF THE DRAWING

A safety device 1 for a motor vehicle comprises a vehicle seat 3 whose seat setting can be adjusted by a seat adjustment drive 2 and which may be any seat of the motor vehicle, in particular even a rear seat. A seat control unit 4 with evaluation of data 5 that is relevant to the safety of a driving mode actuates the seat adjustment drive 2 with timing such that movement of the vehicle seat 3 into a seat setting that is optimum for a vehicle occupant in terms of safety technology is initiated before the occurrence of an anticipated accident event. It is advantageous here if the optimum seat setting in terms of safety technology is brought about before the occurrence of the accident event. If the accident event does not occur, the vehicle seat 3 can be returned to its original seat setting. The data 5 that is relevant to the safety of the driving mode comprises driving state variables, ambient data and/or evaluated driver activities.

The movement of the vehicle seat 3 into an optimum seat setting in terms of safety technology by way of the seat control unit 4 comprises a multiplicity of individual adjustment steps for the respective components of the vehicle seat 3. The individual adjustment steps are carried out successively in a predefined sequence. The adjustment steps for the respective components of the vehicle seat 3 comprise a longitudinal adjustment of the seat, an adjustment of the angle of inclination of the cushion of the seat, an adjustment of the backrest and a vertical adjustment. However, it is also contemplated to carry out further or other adjustment steps.

In this illustrated embodiment, the adjustment steps for the respective components of the vehicle seat 3 are divided into a first group and a second group. The first group comprises the longitudinal adjustment of the seat and the adjustment of the angle of inclination of the cushion of the seat. The second group has the adjustment of the backrest and the vertical adjustment. A sequence for activation of the adjustment steps is predefined for each group so that in each case an adjustment step from the first group and from the second group can be carried out in parallel in terms of timing.

The optimum seat setting in terms of safety technology by the adjustment steps and the sequence of the adjustment steps are dependent on a seatbelt system 6 of the vehicle seat 3 being put on. For a state in which the seatbelt has been put on, the sequence of the adjustment steps is selected such that the longitudinal adjustment of the seat and the adjustment of the backrest are carried out first. For a state in which the seatbelt has not been put on, the processing sequence of the adjustment steps is reversed. Since the optimum seat setting in terms of safety technology differs for the state in which the seatbelt has been put on from the optimum seat setting in terms of safety technology in the state in which the seatbelt has not been put on, for example the adjustment of the angle of inclination of the cushion of the seat for the state in which the seatbelt has been put on has a different adjustment scenario than the state in which the seatbelt has not been put on.

The longitudinal adjustment of the seat is carried out as follows. If the longitudinal adjustment of the vehicle seat 3 is within a first, front predefined adjustment range, the vehicle seat 3 is returned into a first defined absolute position. If the longitudinal adjustment of the vehicle seat 3 is within a second, rear predefined adjustment range, the vehicle seat 3 is moved forward into a second defined absolute position. The absolute positions can be parameterized and respectively have different values for the state in which the seatbelt has been put on and the state in which it has not been put on. The longitudinal adjustment of the seat optimizes the distance of the seat from an airbag which will unfold during the accident event.

The backrest of the seat is moved into a predefined upright position for a predefined range of angles of inclination for the current angle of inclination of the backrest. If the backrest is already in an upright position, the angle of inclination of the backrest is no longer changed. The predefined upright position may vary for the state in which the seatbelt has been put on and the state in which it has not been put on.

If the vertical adjustment of the vehicle seat 3 is in a predefined upper adjustment range, the vehicle seat 3 is moved down to a defined absolute position, with the defined absolute position being in turn dependent on the state of the seatbelt system 6 in which the seatbelt has been put on. The vehicle occupant is thus moved into a position which relates in an optimum way to the unfolding range of the airbag. Head contact with a roof frame can thus be avoided.

The adjustment of the angle of inclination of the cushion of the seat can also be carried out as a function of the state of the seatbelt system 6 in which the seatbelt has been put on. In the state in which the seatbelt has been put on, the angle of inclination of the cushion of the seat is increased to a predefined first angle if the current angle of inclination of the cushion of the seat is below a predefined first threshold value compared to the plane. In the state in which the seatbelt has not been put on, the angle of inclination of the cushion of the seat is lowered to a predefined second angle if the current angle of inclination of the cushion of the seat is above a predefined second threshold value. This allows for the fact that, owing to reasons of safety technology, the angle of inclination of the seat cushion is intended to have a lower angle of inclination in the state in which the seatbelt has not been put on than in the state in which it has been put on.

The optimum seat setting in terms of safety technology and/or the sequence of the adjustment steps thus depend on the current setting of the vehicle seat. However, they can also be dependent on the anticipated accident event.

Furthermore, it is also contemplated by the present invention to provide a vehicle occupant classification feature 7 for the vehicle seat 3 so that the setting of the optimum seat setting in terms of safety technology and/or the definition of the sequence of the adjustment steps are carried out as a function of the vehicle occupant classification feature 7. The setting can also be made dependent on, for example, the size, the weight, the constitution and/or the age of the vehicle occupant.

The safety device 1 according to the present invention ensures a high degree of vehicle occupant protection for a vehicle occupant sitting on the vehicle seat 3. The vehicle seat 3 can already be moved into an optimum seat setting in terms of safety technology before the accident event, with the seat setting being defined as a function of various peripheral conditions. The definition of the sequence of occurrence of the successive individual adjustment steps in order to bring about the seat setting which is optimum in terms of safety technology permits the respective safety measures to be actuated individually and in a way which is appropriate to the situation.

1-9. (canceled)

10. A safety device for a motor vehicle having a vehicle seat whose seat setting can be adjusted by a seat adjustment drive, comprising a seat control unit with evaluation of data that is relevant to safety of a driving mode for actuating the seat adjustment drive with timing such that movement of the vehicle seat into an optimum seat setting for a vehicle occupant in terms of safety technology is initiated before occurrence of an anticipated accident event and is carried out successively in individual adjustment steps for respective components of the vehicle seat in a predefined sequence the seat control unit.

11. The safety device as claimed in claim 10, wherein the adjustment steps for the respective components of the vehicle seat are divided into at least two groups with a predefined sequence in the respective group so that adjustment steps composed of different groups can be carried out in parallel.

12. The safety device as claimed in claim 10, wherein at least one of the optimum seat setting and the sequence of the adjustment steps is dependent on a seatbelt system of the vehicle seat being put on.

13. The safety device as claimed in claim 10, wherein at least one of the optimum seat setting and the sequence of the adjustment steps is dependent on the current seat setting of the vehicle seat.

14. The safety device as claimed in claim 10, wherein a vehicle occupant classifier is provided for the vehicle seat so that at least one of the optimum seat setting and the sequence of the adjustment steps can be determined as a function of the vehicle occupant classifier.

15. The safety device as claimed in claim 14, wherein in the function is at least one of size and weight of the vehicle occupant.

16. The safety device as claimed in claim 10, wherein at least one of the optimum seat setting and the sequence of the adjustment steps is dependent on the anticipated accident event.

17. The safety device as claimed in claim 10, wherein the optimum seat setting is able to be effected before occurrence of an accident event.

18. The safety device as claimed in claim 10, wherein the data comprises at least one of driving state variables, ambient data and evaluated driver activities.

19. The safety device as claimed in claim 10, wherein the vehicle seat is returnable to an original setting thereof if the anticipated accident does not occur.

20. A method comprising evaluating data that is relevant to safety of a driving mode, and using the data for actuating a motor vehicle seat into an optimum seat setting for a vehicle occupant in terms of safety technology before occurrence of an anticipated accident event by successively carrying out the movement in individual steps for respective components of the vehicle seat in a predefined sequence.

21. The method as claimed in claim 20, wherein the adjustment steps for the respective components of the vehicle seat are divided into at least two groups with a predefined sequence in the respective group so that adjustment steps composed of different groups can be carried out in parallel.

22. The method as claimed in claim 20, wherein at least one of the optimum seat setting and the sequence of the adjustment steps is dependent on a seatbelt system of the vehicle seat being put on.

23. The method as claimed in claim 20, wherein at least one of the optimum seat setting and the sequence of the adjustment steps is dependent on the current seat setting of the vehicle seat.

24. The method as claimed in claim 20, wherein the optimum seat setting is able to be effected before occurrence of an accident event.

25. The method as claimed in claim 20, wherein the data comprises at least one of driving state variables, ambient data and evaluated driver activities.

26. The method as claimed in claim 20, wherein the vehicle seat is returnable to an original setting thereof if the anticipated accident does not occur.
